(19) United States
(12) Patent Application Publication
(10) Pub. No.: US 2023/0168715 A1
(43) Pub. Date: Jun. 1, 2023

(54) COMPUTER ACCESSORIES

(71) Applicant: Sandra POPESCU, Toronto (CA)

(72) Inventor: Sandra POPESCU, Toronto (CA)

(21) Appl. No.: 18/070,837

(22) Filed: Nov. 29, 2022

Related U.S. Application Data
(60) Provisional application No. 63/284,053, filed on Nov. 30, 2021.

(51) Int. Cl. G06F 1/16; G06F 3/039; G06F 3/0354

(52) U.S. Cl. CPC G06F 1/163; G06F 3/0395; G06F 3/03547

(57) ABSTRACT

A computer accessory including a base, a strap and an attachment mechanism. The base includes a mouse pad portion. The strap is attachable to the base, and the strap is used to secure the attachment mechanism.. The attachment mechanism is to removably attach the device to a user's clothing, belt or fitment. A barrier may also extend at the edge of the mouse pad portion. Alternatively, the base includes a touch pad portion or track pad portion for use as a computer mouse, or the base includes a rollerball mouse portion for use as a computer mouse. The user may thus be able to use the computer accessory in place of a traditional computer mouse. Advantages provided by the computer accessory include pain and stress relief, ease of alternating between mouse use and keyboard use, portability, ease of switching between the left and right hands, and use in a variety of orientations that can cater to the user's personal needs.

### FIELD

The present disclosure is in the field of computer accessories, and more particularly a computer accessory for limiting musculoskeletal injuries.

### BACKGROUND

Continuous use of a computer mouse while operating a computer can lead to repetitive stress injuries. The position of a shoulder tensed to hold an arm bent at the elbow and hand twisted at the wrist at the same angle for multiple hours every day, while operating a table-top computer mouse, will cause the computer user to experience various degrees of discomfort and fatigue manifested by musculoskeletal stress and strain in the user's hand, wrist, arm, elbow, and shoulder, further leading to repetitive strain injuries of various degrees. Therefore, there remains a need for a computer mouse solution that is more effective at limiting various musculoskeletal injuries.

### SUMMARY

According to a first aspect of the specification, a computer accessory includes a base, a strap and an attachment mechanism. The base includes a mouse pad portion. The strap is attachable or attachable to the base, and the strap is used to secure the base to the attachment mechanism. The attachment mechanism can removably attach the computer accessory to the user's clothing, belt or fitment.

According to another aspect of the specification, a computer accessory includes a base, a strap and an attachment mechanism. The base includes a touch pad portion for use as a computer mouse. The strap is attached or attachable to the base, and the strap is used to secure the base to the attachment mechanism. The attachment mechanism can removably attach the computer accessory to a user's clothing, belt or fitment.

According to yet another aspect of the specification, a computer accessory includes a base, a strap and an attachment mechanism. The base includes a rollerball mouse portion for use as a computer mouse. The strap is attached attachable to the base, and the strap is used to secure the base to an attachment mechanism. The attachment mechanism can removably attach the computer accessory to a user's clothing, belt or fitment.

### BRIEF DESCRIPTION OF THE DRAWINGS

FIG. 1 depicts a top perspective view of an example computer accessory with strap and attachment mechanism.

FIG. 2 depicts side elevation view of the example computer accessory with strap and attachment mechanism of FIG. 1.

FIG. 3 depicts an exploded perspective view of the example computer accessory of FIG. 1.

FIG. 4 depicts a perspective view of the example computer accessory with strap of FIG. 1 in operation by a user.

FIG. 5 depicts a bottom perspective view of another embodiment of the example computer accessory of FIG. 1.

FIG. 6 depicts a bottom perspective view of another embodiment of the example computer accessory of FIG. 1 where the attachment mechanism is directly fastened to the base.

FIG. 7 depicts a top view of an example computer accessory featuring a touch pad or track pad portion.

FIG. 8 depicts a top view of an example computer accessory featuring a rollerball mouse portion.

FIG. 9 depicts another embodiment of the example computer accessory of FIG. 8.

FIG. 10 depicts another embodiment of the example computer accessory of FIG. 1.

FIG. 11 depicts a perspective view of a further embodiment of computer accessory featuring a barrier at the edge of the mouse pad portion.

### DETAILED DESCRIPTION

The daily use of table-top computers for multiple hours is a major part of the lives of many people around the world. As such, the musculoskeletal stress and strain that a user's hand, wrist, arm, elbow and shoulder may suffer can lead to a variety of repetitive strain injuries.

A computer accessory is presented which eliminates the need to use a computer mouse at a table-top. This freedom can reduce the musculoskeletal stress and strain associated with traditional table-top computer mouse usage and can thus reduce the likelihood of repetitive strain injuries, carpal tunnel syndrome, tennis elbow, shoulder rotator cuff injury, muscle spasm or strain, tendonitis, ligament strains and/or joint dysfunction, but also arthritis, distress and displacements of the hand, wrist, arm, elbow, shoulder, neck and back areas. Users may be able to use the computer accessory in different orientations, for example, while keeping their elbow in a natural position. Further, use of the computer accessory may be alternated between the left and right hands with no changes in configuration to the device. The computer accessory is highly portable, and lightweight so that it may be easily transported in a backpack, satchel, briefcase or other carrying device. Thus, the likelihood of repetitive strain injuries may be reduced or even obviated via use of the computer accessory presented herein.

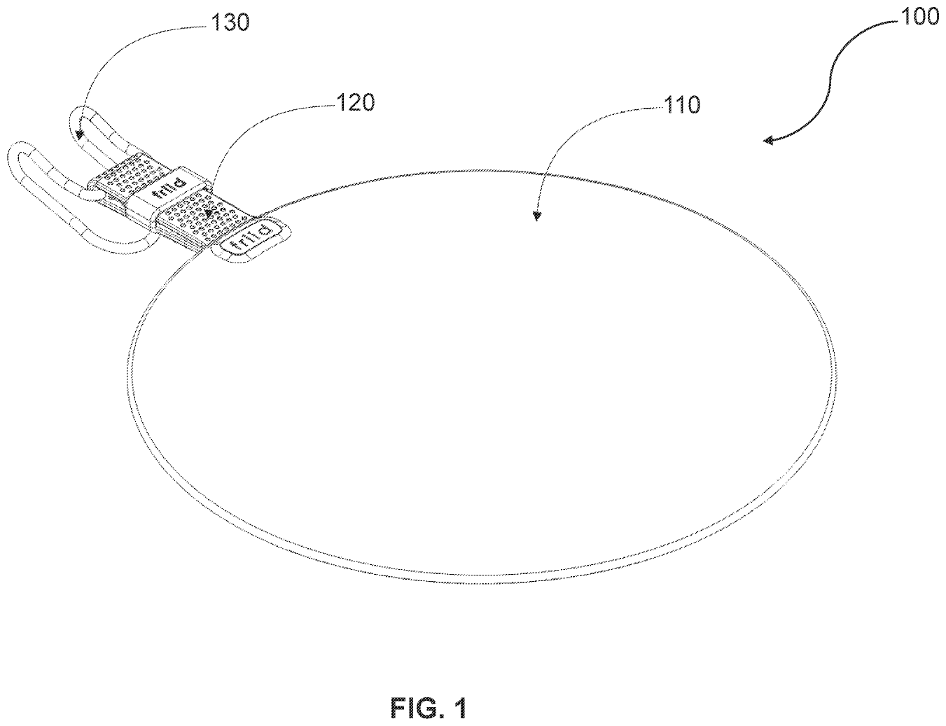

FIG. 1 depicts a top perspective view of an example computer accessory 100. The computer accessory 100 includes a base 110, a strap 120 and an attachment mechanism 130. The strap 120 is attached or attachable to the base 110, and the strap 120 is used to secure the base to the attachment mechanism. The attachment mechanism 130 can removably attach the strap 120 to a user's clothing, belt or fitment.

The strap 120 and the attachment mechanism 130 allow for quick and easy attachment and removal. For example, the attachment mechanism 130 may be quickly and easily attached to or removed from a user's clothing, belt or fitment. The attachment mechanism 130 therefore also allows a user to switch the computer accessory 100 between their right and left hands very easily. Furthermore, the attachment mechanism 130 allows a user to move their arm around with confidence that the computer accessory 100 will not become detached from their person.

The base 110 may be comprised of a lightweight solid material with a surface similar to that of a mouse pad such as carbon fiber, rubber, silicone, cloth, fiber or microfiber, foam, plastic, 3-D cloth, high-density processed cloth materials, metal, finely textured material, thermoplastic elastomers, plastic or wood assembly, or the like. In some embodiments, the base 110 is comprised of rubber, silicon, steel, aluminum, carbon fiber, plastic, wood or other natural materials, or a combination thereof. In some embodiments the base has a diameter between about 2 inches and 10 inches.

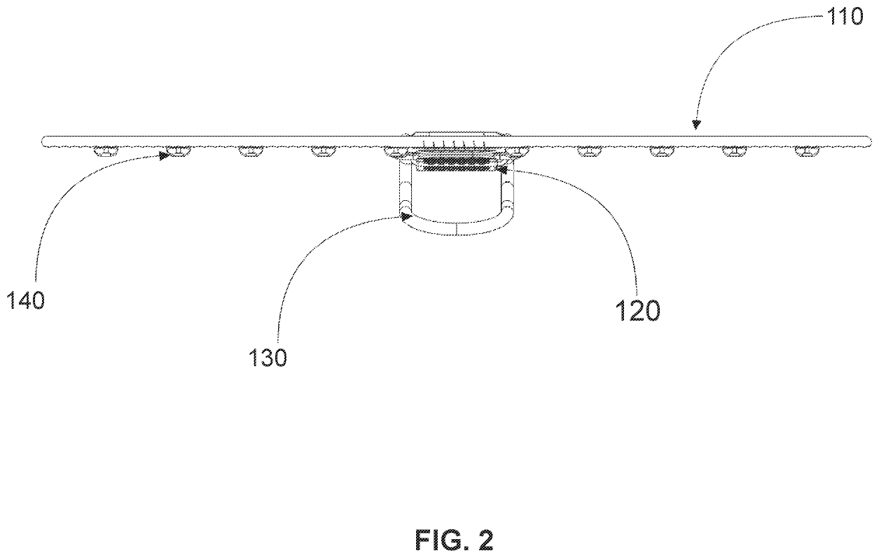

Referring now to FIG. 2, a side elevation view of an example computer accessory 100 is depicted. This depiction provides an example visual comparison of the width of the base 110 to the strap 120 and attachment mechanism 130, as well as showing a plurality of underside support ribs 140. Further, the strap 120 may have an adjustable aspect, allowing users with heights of varying sizes to comfortably use the computer accessory 100.

The attachment mechanism 130 may be implemented in several different ways. As shown in FIGS. 1 and 2, the attachment mechanism 130 may be in the form of a hook that is attached to the strap 120 to allow for fast and easy connection and disconnection between the computer accessory 100 and the user's clothing, belt or fitment. Similarly, the attachment mechanism 130 may be in the form of or may include prongs and holes, snap, button, magnet, clasp, clamp, bracket, brace, clip, tension mechanism, a hook and loop fastener such as Velcro™ or any other suitable mechanism.

The strap 120 may be an adjustable band that users are able to attach to the attachment mechanism 130. The strap 120 may be comprised of rubber, silicon, thermoplastic elastomers, steel, aluminum, carbon fiber, plastic, nylon, magnetic materials, textile materials, wood, cotton or a combination thereof. The strap 120 may also take the form of other types of bands, such as those produced from a heavy fabric or similar textile material, rubber, silicon, magnetic materials, steel, aluminum, carbon fiber, plastic, nylon or similar material, which may also allow for adjustment.

The ribs 140 may reinforce the base 110 and may prevent it from bending when in use. Additionally, the ribs 140 may provide necessary friction for example when the computer accessory 100 is in function on a user's lap. The ribs 140 may be comprised of rubber, silicon, thermoplastic elastomers, steel, aluminum, carbon fiber, plastic, nylon, magnetic materials, textile materials, wood, cotton or a combination thereof. The ribs 140 may be of different lengths, thickness, shapes or formation of shapes and may also take the form of other types of spines, such as those produced from a heavy fabric or similar textile material, rubber, silicon, magnetic materials, steel, aluminum, carbon fiber, plastic, nylon or similar material, which may also allow for adjustment.

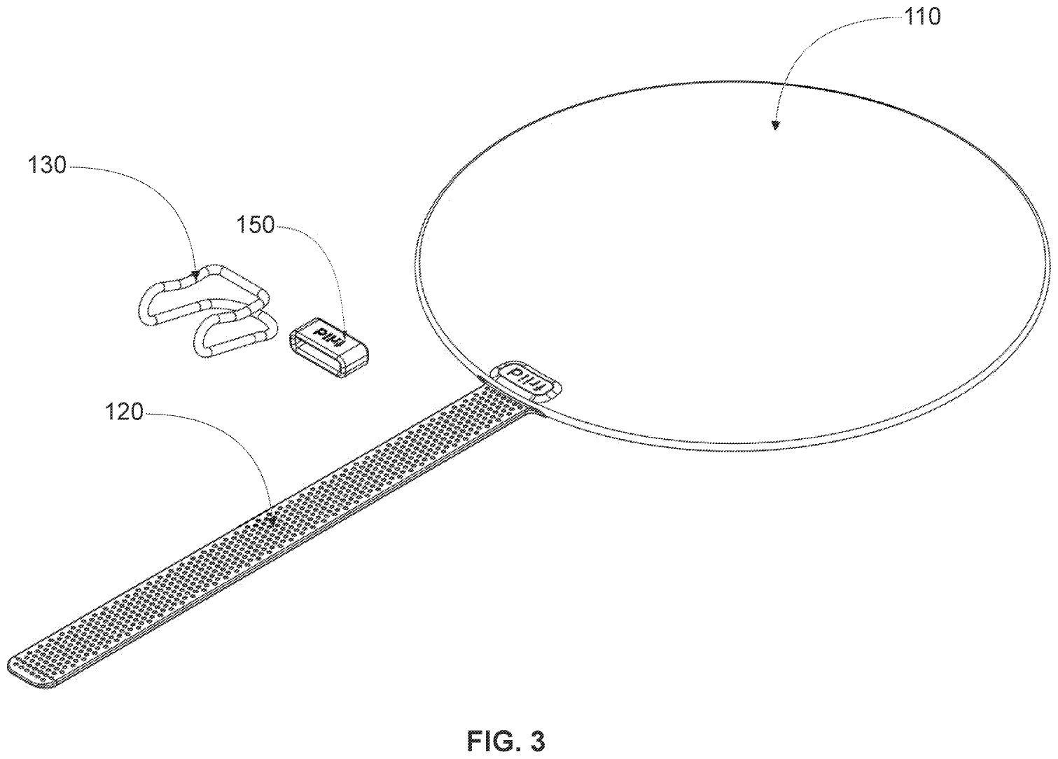

FIG. 3 depicts an exploded view of an example computer accessory 100, wherein the attachment mechanism 130 is shown as separated from the base 110. An optional retaining ring loop keeper 150 is also shown which, in certain embodiments, may assist with the adjustment of the length of the strap 120.

The retaining ring loop keeper 150 may reinforce the hold of the strap 120 and may prevent it from loosening while in use. The retaining ring loop keeper 150 may be comprised of rubber, silicon, thermoplastic elastomers, steel, aluminum, carbon fiber, plastic, nylon, magnetic materials, textile materials, wood, cotton or a combination thereof. The retaining ring loop keeper 150 may also take the form of other types of security loops, such as those produced from a heavy fabric or similar textile material, rubber, silicon, magnetic materials, steel, aluminum, carbon fiber, plastic, nylon or similar material, which may also allow for adjustment.

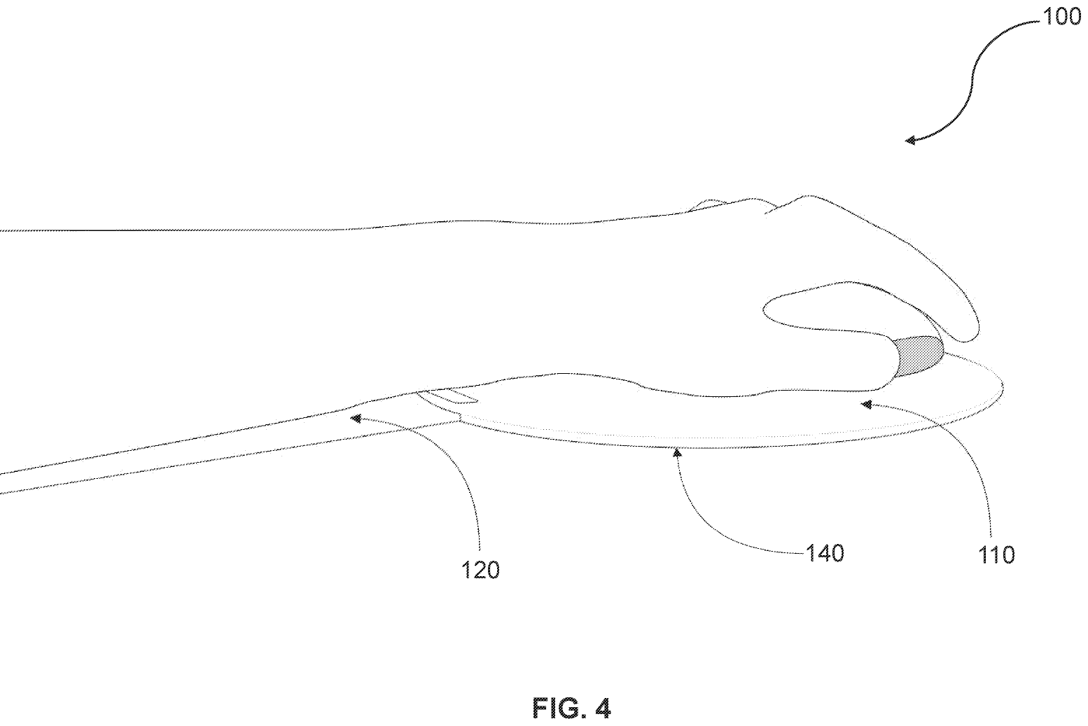

FIG. 4 depicts a perspective view of an example computer accessory 100 in operation by a user's hand. While the user is shown using the computer accessory 100 with their left hand, the skilled person will reasonably understand that the computer accessory 100 may be alternatively used by either left-handed users or right-handed users, without additional configuration.

Due to the nature of the attachment mechanism 130 to the strap 120 of the base 110, the user may choose to use the computer accessory 100 while sitting by placing the computer accessory 100 on their lap or on an adjacent surface.

The comparison in size between the computer accessory 100 and the user's hand also illustrates how the size of the computer accessory 100 makes it an extremely portable device.

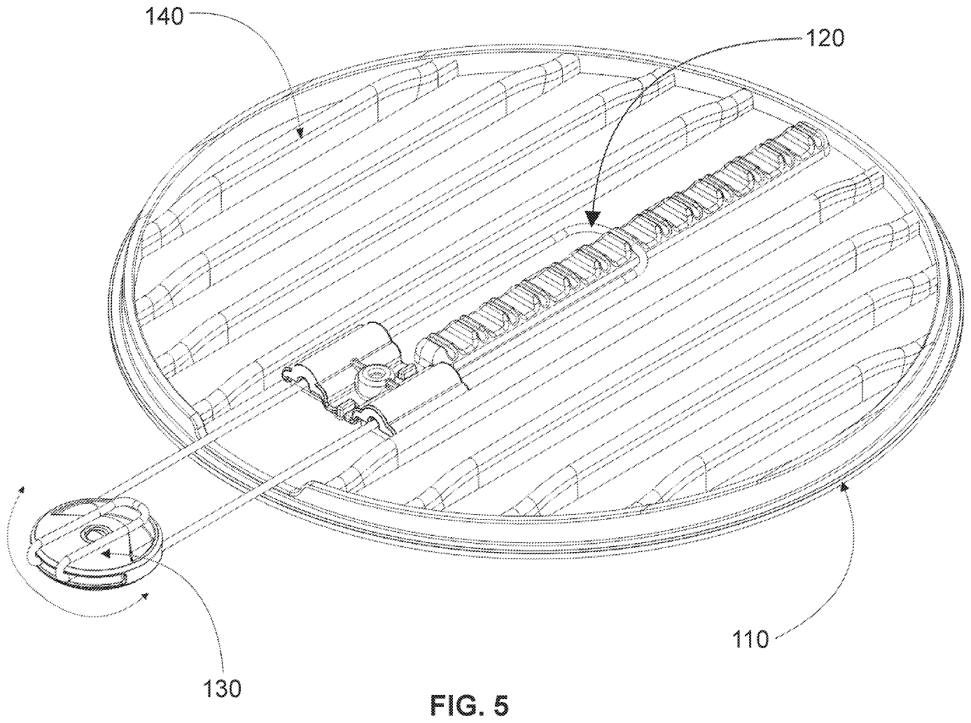

Referring now to FIG. 5, a bottom perspective view of an alternative embodiment of the example computer accessory 100 is depicted. In this embodiment, the strap 120 is shown as an adjustable wire arm that snaps into a track built into the base 110, the track providing options for various lengths of the strap 120. This does not hinder the ability of the attachment mechanism 130 to attach to or be removed from a user's clothing, belt or fitment and may appeal to users who prefer more of a mechanical look. The attachment mechanism 130 may be able to pivot on its axis so to allow for various hooking positions onto a user's clothing, belt or fitment.

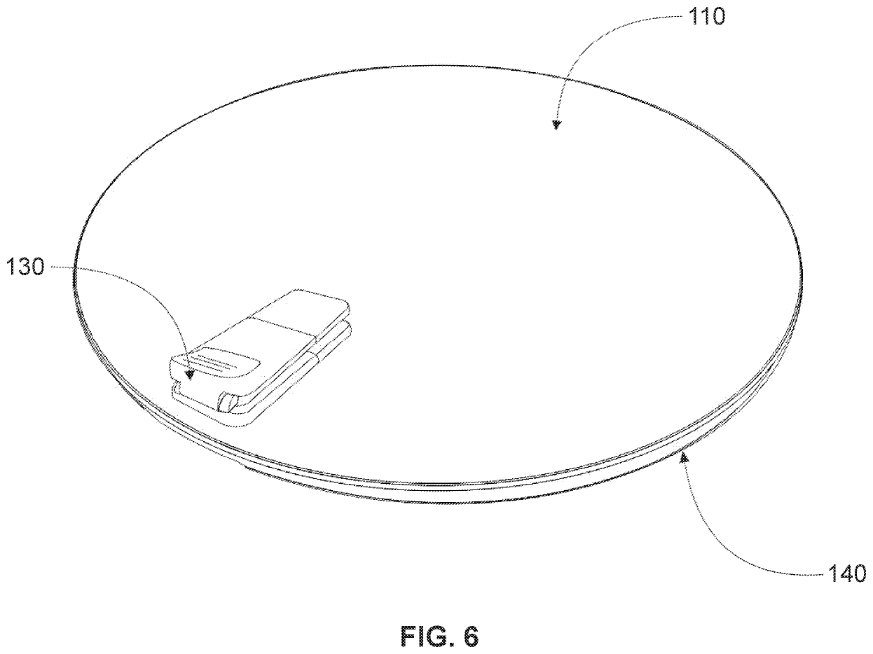

Referring now to FIG. 6, a bottom perspective view of a further alternative embodiment of the computer accessory 100 is depicted. In this embodiment, the attachment mechanism 130 may consist of a clip directly attached to the base 110 The clip material may be a plastic, thick fabric, leather, textile material, rubber, silicon, magnetic materials, steel, aluminum, carbon fiber, thermoplastic elastomers, nylon or similar material, which may also allow for adjustment. In this alternative embodiment, the strap 120 may or may not be present.

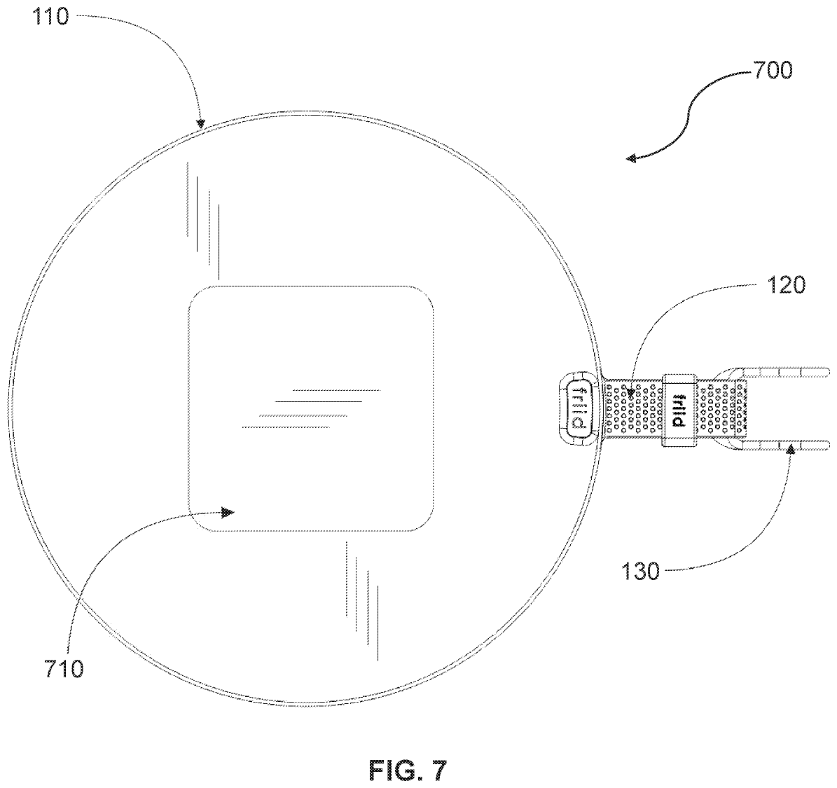

Referring now to FIG. 7, in another embodiment, a computer accessory 700 includes a base 110, a strap 120 and an attachment mechanism 130. The base 110 includes a touch pad portion or track pad portion 710 for use as a computer mouse. The user may thus be able to use the computer accessory 700 in place of a traditional computer mouse. The size of the base 110 and the size of the track pad portion 710 may vary in relation to the size of the base 110. In some embodiments, the track pad portion 710 may be larger, covering more area on the base 110, while in other embodiments the track pad portion 710 may be limited to a smaller area. The track pad portion 710 may be electronically integrated into the base 110, such that the computer accessory 700 may be wired or wirelessly connected to a computer system. By way of example only, sensors may be dispersed about the track pad portion 710 with each sensor representing an x and y position on a Cartesian coordinate system. Sensors may typically be arranged in columns and rows in a grid-like fashion. Using this example system, distinct x and y position signals may be generated when a user moves their finger across the grid of sensors within the track pad portion 710. This in turn can control the x and y movement of a pointer device on a display screen. The sensors in the track pad portion 710 may include resistive sensors, surface acoustic wave sensors, pressure sensors, optical sensors, capacitive sensors or the like.

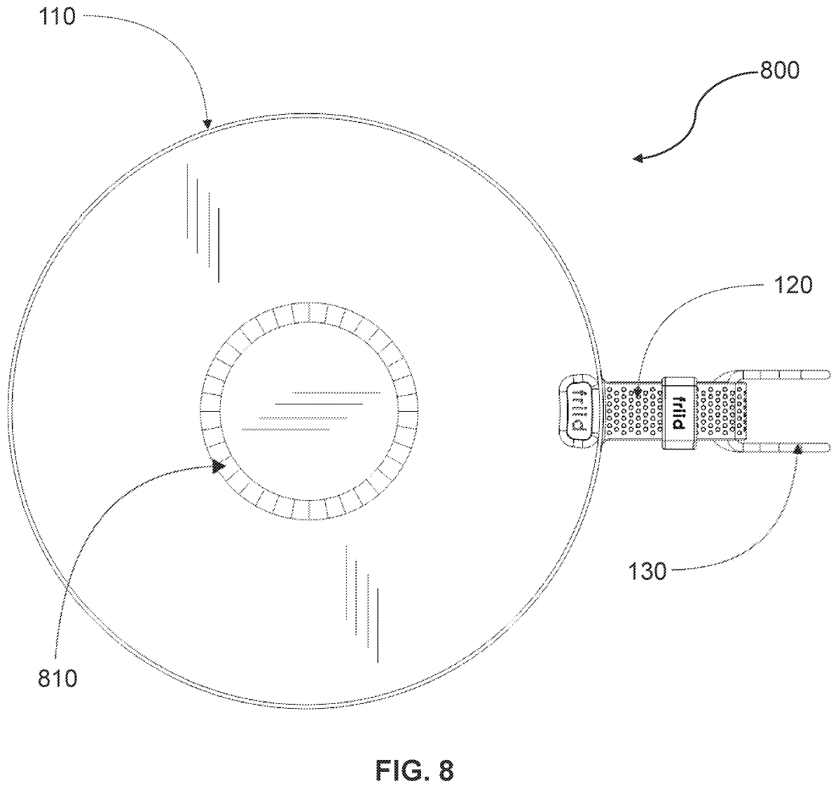

Referring now to FIG. 8, in another embodiment, a computer accessory 800 includes a base 110, a strap 120 and an attachment mechanism 130. The base 110 includes a rollerball mouse portion 810 for use as a computer mouse. The user may thus be able to also use the computer accessory 800 in place of a traditional computer mouse. The rollerball mouse portion 810 may be electronically integrated into the base 110, such that the computer accessory 800 may be wired or wirelessly connected to a computer system. The size of the base 110 and the roller ball mouse portion 810 may vary. By way of example only, sensors may be placed within the rollerball mouse portion 810 with each sensor representing an x and y position on a Cartesian coordinate system. Using this example system, distinct x and y position signals may be generated when a user moves the rollerball mouse portion 810. This in turn can control the x and y movement of a pointer device on a display screen. The sensors in the rollerball mouse portion 810 may include resistive sensors, surface acoustic wave sensors, pressure sensors, optical sensors, capacitive sensors or the like.

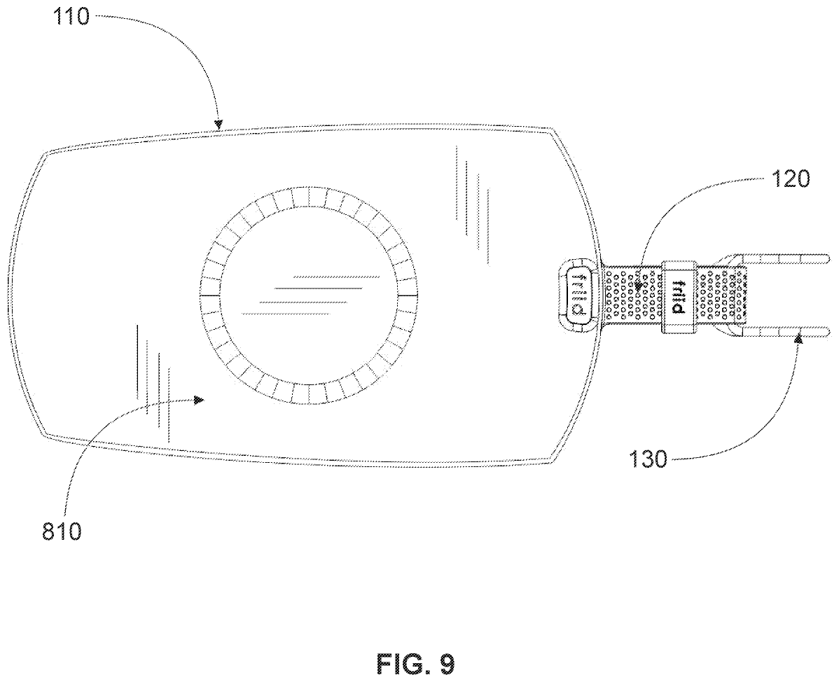

FIG. 9 depicts an example alternative embodiment of the computer accessory 800 in FIG. 8, in which the base 110 may have a narrow generally-rectangular shape. This reduction is size may greatly increase the portability of the computer accessory 800. The skilled person will appreciate that the shape and size of the base 110 of all computer accessories described herein is not limited to one particular configuration.

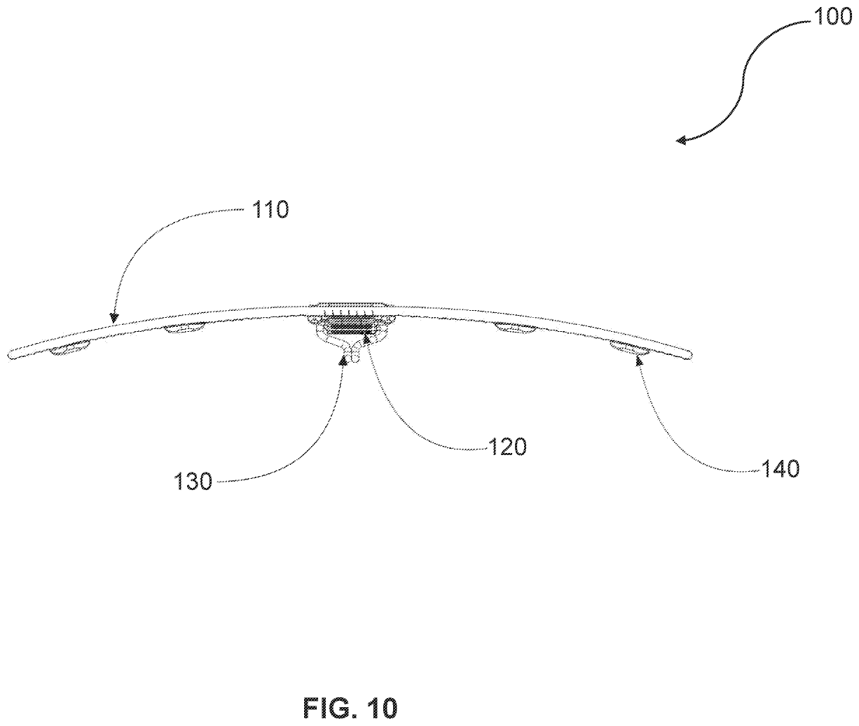

FIG. 10 is a side elevation view of an example alternative embodiment of the computer accessory 100 in FIG. 1, in which the base 110 may have a curved shape. This alteration in shape allows for use of a computer mouse when there is no flat surface to support it, such as on a user's lap or while the user is standing.

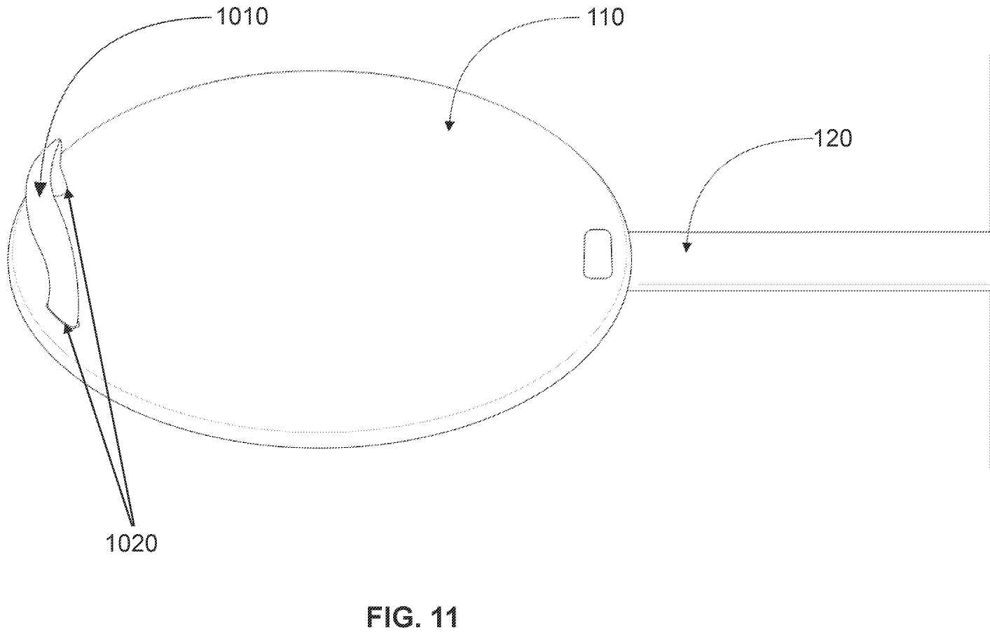

Referring now to FIG. 11, in some embodiments, a computer accessory 100 may include one or more barriers 1010 that extend at the edge of the base 110, and may be attached to the base 110 at attachment points 1020, to provide a delineated scrolling surface for the computer mouse. In some embodiments, the barrier 1010 may be sized for small, medium and large user hands. In some embodiments, the barrier 1010 may be sized for small, medium and large computer mice and may be adjustable.

The barrier 1010 may be comprised of rubber, silicon, magnetic materials, steel, aluminum, thermoplastic elastomers, carbon fiber, plastic, nylon, wood, metal, textile or other natural materials, cotton or a combination thereof. The barrier 1010 may create a cavity for a user to operate the various scroll options and click-buttons of the computer mouse. The design of the computer accessories herein may also be purposely enhanced for specific mouse uses, such as office and professional use, home or gaming use, and may be enhanced with possible sensor-reactive coating, anti-microbial fabric or matter, 3D and 4D capabilities etc. as technology advances.

The barrier 1010 may allow for the user's hand to control the mouse in any position and at any angle on any axis, providing relief from long-term holding of strenuous positions. The barrier 1010 may attach to an edge of the base 110, whereby a hand grasping the mouse can slide across the surface 1020, and whereby the barrier 1010 operates to prevent the computer mouse from sliding off the surface.

In some embodiments, the computer accessories disclosed herein may possess a wired or wireless connection to a computer.

Thus, a portable computer accessory with an adjustable strap is provided whereby the computer accessory may be used alternatively in a left-handed or right-handed configuration and in a variety of orientations depending upon the user's comfort or personal needs.

The scope of the claims should not be limited by the embodiments set forth in the above examples but should be given the broadest interpretation consistent with the description as a whole.

1. A computer accessory, comprising:
a base;
a strap attached or attachable to the base,; and
an attachment mechanism to attach the computer accessory to a user's clothing, belt or fitment.

2. The computer accessory of claim 1, wherein the strap is adjustable for length.

3. The computer accessory of claim 1, wherein the attachment mechanism is in the form of a hook that is attached to the strap to allow for connection and disconnection between the computer accessory and the user's clothing, belt or fitment.

4. The computer accessory of claim 1, wherein the attachment mechanism includes at least one of prongs and holes, snap, button, magnet, clasp, clamp, bracket, brace, clip, tension mechanism and a hook and loop fastener.

5. The computer accessory of claim 1, wherein the base is circular and has a diameter between about 2 inches and 10 inches.

6. The computer accessory of claim 1, wherein the base has a narrow generally-rectangular shape.

7. The computer accessory of claim 1, wherein a surface of the base is comprised of at least one of carbon fiber, rubber, silicone, cloth, fiber or microfiber, foam, plastic, 3-D cloth, high-density processed cloth materials, metal, finely textured material, thermoplastic elastomers, plastic and wood.

8. The computer accessory of claim 1, wherein the base is comprised of at least one of rubber, silicon, steel, aluminum, carbon fiber, plastic and wood.

9. The computer accessory of claim 1, wherein the base includes a plurality of underside support ribs.

10. The computer accessory of claim 1, wherein the strap is comprised of at least one of rubber, silicon, thermoplastic elastomers, steel, aluminum, carbon fiber, plastic, nylon, magnetic materials, textile materials, wood and cotton.

11. The computer accessory of claim 1, wherein the strap comprises a band fabricated from at least one of heavy fabric, textile material, rubber, silicon, magnetic material, steel, aluminum, carbon fiber, plastic and nylon.

12. The computer accessory of claim 9, wherein the underside ribs are comprised of at least one of rubber, silicon, thermoplastic elastomers, steel, aluminum, carbon fiber, plastic, nylon, magnetic materials, textile materials, wood and cotton.

13. The computer accessory of claim 1, wherein the strap comprises an adjustable wire arm that snaps into a track in the base, wherein the track provides for various lengths of the strap.

14. The computer accessory of claim 1, wherein the attachment mechanism is adapted to pivot on an axis so to allow for various attachment positions onto a user's clothing, belt or fitment.

15. The computer accessory of claim 1, wherein the base includes one of either a touch pad portion or track pad portion for use as a computer mouse.

16. The computer accessory of claim 1, wherein the base includes one or more barriers that extend at an edge of the base, to provide a delineated scrolling surface for a computer mouse.

17. The computer accessory of claim 16, wherein the one or more barriers are attached to the base at attachment points.

18. The computer accessory of claim 1, wherein the base includes a rollerball mouse portion for use as a computer mouse.

19. The computer accessory of claim 1, wherein the base is curved.

20. A computer accessory, comprising:
a base; and
an attachment mechanism to attach the computer accessory to a user's clothing, belt or fitment, wherein the attachment mechanism comprises a clip that attaches to the base.

21. The computer accessory of claim 20, wherein the clip is fabricated from at least one of plastic, thick fabric, leather, textile material, rubber, silicon, magnetic materials, steel, aluminum, carbon fiber, thermoplastic elastomers and nylon.
